(19) United States
(12) Patent Application Publication
(10) Pub. No.: US 2026/0037985 A1
(43) Pub. Date: Feb. 5, 2026

(54) TECHNIQUES FOR APPLYING PREDICTIVE ANALYTICS TO USAGE DATA IN AN EVENT-DRIVEN ARCHITECTURE

(71) Applicant: Barclays Services Corporation, New York, NY (US)

(72) Inventors: Daron FINN, Flemington, NJ (US); Chandra PENAGANTI, Middletown, DE (US); Shrey MAHAJAN, Jersey City, NJ (US); Aritra ROYCHOUDHURY, Morris Plains, NJ (US); Bethany MCKELVEY, Newark, DE (US); Allison KEEVIL, West Grove, PA (US); Sean H. MURRAY, West Chester, PA (US)

(73) Assignee: Barclays Services Corporation, New York, NY (US)

(21) Appl. No.: 18/791,160

(22) Filed: Jul. 31, 2024

(51) Int. Cl. G06Q 30/015

(52) U.S. Cl. CPC G06Q 30/015

(57) ABSTRACT

Techniques for applying predictive analytics to usage data in an event-driven architecture comprise systems, methods and storage mediums. A system having an event-driven architecture that facilitates proactive engagement with a customer over a network may comprise a memory storing instructions, a data storage that stores prompt data of one or more customer actions, and one or more processors. The one or more processors may execute the instructions to receive customer input data from the customer, provide the customer input data to a streaming inference engine that identifies one or more customer usage patterns, generate a customer servicing model based on the one or more customer usage patterns and the prompt data, store the customer servicing model in the data storage, provide an output to the customer based on the customer servicing model, and continuously update the customer servicing model stored in the data storage.

### FIELD OF THE DISCLOSURE

The present disclosure relates generally to pattern recognition and predictive modelling and, more particularly, to techniques for applying predictive analytics to usage data in an event-driven architecture.

### BACKGROUND OF THE DISCLOSURE

Financial institutions, such as consumer banks, receive many customer calls at their contact centers after the customers fail to complete an action on their own though the bank's website or mobile application. For example, a customer may attempt to make a payment online yet abandon the payment before it is complete for any number of reasons (e.g., the financial institution's website goes down, the customer's internet connection goes down, the customer has a question that they cannot easily resolve, etc.). The customer's abandoned action is not only a negative experience from their perspective, but it is also an expense to the bank to provide resources and support at the call center that could be utilized elsewhere to improve the customer's experience.

Financial institutions currently offer customer-facing support solutions with limited functionality that often leads to the customer calling in despite the availability of such solutions. Chatbots and digital assistants are offered as a personalized solution to assist customers, however they face several significant drawbacks. Current solutions are unable to anticipate that a customer is likely going to call in fast enough to proactively reach out to the customer before they contact their bank. What support is provided to the customer is often generic and does not specifically address the pain point(s) experienced by the individual customer. Thus, it would be helpful to provide a solution to recognize a pattern of customer behavior that indicates the customer is likely to request support and then provide the customer with targeted and personalized support that significantly reduces or even eliminates any need for further support.

In view of the foregoing, it may be understood that there may be significant problems and shortcomings associated with current customer service technologies.

### SUMMARY OF THE DISCLOSURE

Techniques for applying predictive analytics to usage data in an event-driven architecture are disclosed. In one particular embodiment, the techniques may be realized as a system having an event-driven architecture that facilitates proactive engagement with a customer. The system may comprise a memory storing instructions, a data storage that stores prompt data of one or more customer actions, and one or more processors that execute the instructions to receive customer input data from the customer, provide the customer input data to a streaming inference engine that identifies one or more customer usage patterns, generate a customer servicing model based on the one or more customer usage patterns and the prompt data, store the customer servicing model in the data storage, provide an output to the customer based on the customer servicing model, and continuously update the customer servicing model stored in the data storage.

In accordance with other aspects of this particular embodiment, continuously update the customer servicing model may comprise update the customer servicing model according to a timing schedule.

In accordance with further aspects of this particular embodiment, the customer servicing model may be a deep neural network based on a Transformer architecture.

In accordance with additional aspects of this particular embodiment, the customer input data may be received through a digital assistant and the one or more processors may execute the instructions upon determining the customer logged in to a website that provides the digital assistant.

In accordance with other aspects of this particular embodiment, the one or more processors may execute the instructions to identify the one or more customer usage patterns using the stream inference engine, and acquire the prompt data from a plurality of customer interactions with the digital assistant.

In accordance with further aspects of this particular embodiment, the one or more processors may execute the instructions to communicatively couple an event bus to one or more digital channels.

In accordance with additional aspects of this particular embodiment, the one or more processors may execute the instructions to receive the customer input data from the one or more digital channels through the event bus.

In accordance with other aspects of this particular embodiment, the one or more processors may execute the instructions to generate by an Enterprise AI platform, one or more personalized messages based on providing the customer input data to a generative artificial intelligence-based model, and providing the one or more personalized messages to the customer in the output.

In accordance with additional aspects of this particular embodiment, the generative artificial intelligence-based model includes a large language model.

In accordance with further aspects of this particular embodiment, the one or more processors may execute the instructions to communicatively couple an event bus to one or more assisted digital channels.

In accordance with additional aspects of this particular embodiment, the one or more processors may execute the instructions to determine a type of sentiment by performing a sentiment analysis of the customer input data, determine a customer care agent score associated with the type of sentiment, and establish a connection from the customer to the customer care agent through the one or more assisted channels, the connection included in the output.

In accordance with other aspects of this particular embodiment, the customer input data may comprise voice data and the type of sentiment may comprise a level of stress.

In accordance with further aspects of this particular embodiment, the one or more processors may execute the instructions to determine the customer abandoned an action on a webpage, save a snapshot of data based on the abandoned action, and provide a selectable digital link to the customer in real time to resume the action upon selecting the selectable link, the selectable link included in the output.

In accordance with additional aspects of this particular embodiment, the one or more customer actions include a text input, a voice input, a selection on a website, or a series of clicks.

In another particular embodiment, the techniques may be realized as a method of operating a system having an event-driven architecture that facilitates proactive engagement with a customer. The method may comprise the steps of storing instructions in a memory, storing prompt data of one or more customer actions in a data storage, and one or more processors executing the instructions to receive customer input data from the customer, provide the customer input data to a streaming inference engine that identifies one or more customer usage patterns, generate a customer servicing model based on the one or more customer usage patterns and the prompt data, store the customer servicing model in the data storage, provide an output to the customer based on the customer servicing model, and continuously update the customer servicing model stored in the data storage.

In accordance with other aspects of this particular embodiment, continuously update the customer servicing model may comprise update the customer servicing model according to a timing schedule.

In accordance with further aspects of this particular embodiment, the customer servicing model is a deep neural network based on a Transformer architecture.

In accordance with additional aspects of this particular embodiment, receive the customer input data may comprise receive the customer input data through a digital assistant and the one or more processors may execute the instructions upon determining the customer logged in to a website that provides the digital assistant.

In accordance with other aspects of this particular embodiment, the one or more processors may execute the instructions to determine a type of sentiment by performing a sentiment analysis of the customer input data, determine a customer care agent score associated with the type of sentiment, and establish a connection from the customer to the customer care agent through the one or more assisted channels, the connection included in the output.

In accordance with further aspects of this particular embodiment, the customer input data may comprise voice data and the type of sentiment may comprise a level of stress.

In accordance with further aspects of this particular embodiment, the one or more processors may execute the instructions to communicatively couple an event bus to one or more assisted digital channels.

In accordance with additional aspects of this particular embodiment, the one or more processors may execute the instructions to receive the customer input data from the one or more digital channels through the event bus.

In accordance with other aspects of this particular embodiment, the one or more processors may execute the instructions to generate by an Enterprise AI platform, one or more personalized messages based on providing the customer input data to a generative artificial intelligence-based model, and providing the one or more personalized messages to the customer in the output.

In accordance with further aspects of this particular embodiment, the generative artificial intelligence-based model includes a large language model.

In accordance with additional aspects of this particular embodiment, the one or more processors may execute the instructions to determine the customer abandoned an action on a webpage, save a snapshot of data based on the abandoned action, and provide a selectable digital link to the customer in real time to resume the action upon selecting the selectable link, the selectable link included in the output.

In accordance with other aspects of this particular embodiment, the one or more customer actions include a text input, a voice input, a selection on a website, or a series of clicks.

In another particular embodiment, the techniques may be realized as at least one processor readable storage medium storing a computer program of instructions configured to be readable by at least one processor for instructing the at least one processor to execute a computer process for performing the method.

In another particular embodiment, the techniques may be realized as a non-transitory computer readable medium storing a computer program of instructions configured to be executed by one or more processors of the system to execute a computer process for performing the method.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows an event-driven architecture in accordance with an embodiment of the present disclosure.

FIG. 2 shows a customer servicing model generation process in accordance with an embodiment of the present disclosure.

FIG. 3A shows a customer process in an event-driven architecture, where the process and architecture is a combination of FIG. 3B, FIG. 3C, FIG. 3D, and FIG. 3E (as shown in FIG. 3A) in accordance with an embodiment of the present disclosure.

### DETAILED DESCRIPTION OF EMBODIMENTS

In the following detailed description, for purposes of explanation and not limitation, specific details are set forth in order to provide a better understanding of the present disclosure. It will be apparent to one skilled in the art that the present disclosure may be practiced in other embodiments that depart from these specific details.

Proactively messaging customer, as described herein, leads to faster resolutions of customer problems, a reduction in contact center expenses, and an increase in available resources (e.g., man hours and budget) to better serve customers. About one-third or more of consumer bank contact expenses today are attributable to lack of proactive messaging. Of all the reasons customers call in, payments account for about one-fifth of the calls.

Customers often call financial service providers after experiencing an issue with a service they provide. Examples of services include accepting deposits, providing checking and savings accounts, loans, and credit cards. A common occurrence that precedes a customer contacting support personnel at a financial service provider (e.g., via a phone number, email address, or chat interface) is a failed attempt to complete a self-service action on a channel that connects the customer to the financial service provider (e.g., customer tried and was unable to make a payment).

A channel is, in at least some examples, a medium through which information is transmitted from a sender to a receiver. In the context of financial services, a channel may be an online platform or tool that customers use to interact with or otherwise communicate information to a financial services provider. In some examples a digital channel may include little to no human interaction by the provider (e.g., mobile banking app, chatbot, smart assistant). In some examples an assisted channel supplements the communication with human support (e.g., customer support toll free number). Embodiments described herein are not limited to these examples.

Current technologies that aim to resolve customer issues entirely or almost entirely using computers and automated processes (e.g., chatbots) often leave customers feeling frustrated. Consequentially, many customers often still resort to self-service and/or require human interaction to ultimately resolve their problems despite attempting to initially intending to resolve their issues digitally. Unsurprisingly, many customers do not want to have to call customer care hotlines due to long wait times and care agents being selected on rudimentary decision logic, such as simply putting the incoming callers into a queue in a first-in-first-out approach. This can cause customers to abandon the attempt to resolve their issue.

At an industry level, financial service providers or companies (e.g., banks) dealing in deposits face losing profits at the expense of servicing costs of maintaining smart digital assistants and chatbot solutions. Financial instruments (e.g., credit cards, debit cards) face similar servicing costs.

The techniques described herein may replace existing chatbot services with immediate, contextual, omni channel service to customers, with hyper personalization enabled by an enterprise AI solution. To implement these techniques, an event-driven architecture may be used.

An event-driven architecture in some embodiments is a computer system having a particular software design pattern between multiple components thereof. The event-driven architecture facilitates real-time data flow between decoupled applications and services. The components of an event-driven architecture include event producers, event routers, and event consumers. Each of these components communicates through an intermediary component called an event bus. An event producer is, in some examples, a source of data provided to the event-driven architecture. An online bookstore, for example, may be configured as an event producer that generates an event indicating a new book order being placed. The event may be sent to the event bus and then through one or more event routers before an event consumer, such as a warehouse, checks the event bus to receive the event ordering the book.

An event in an event-driven architecture may be a change in state or an update. An event may also be an action that occurs internally within an organization or externally from the organization. Accordingly, some events may signify anything of value to a company or other organization, such as a financial service provider (e.g., a bank).

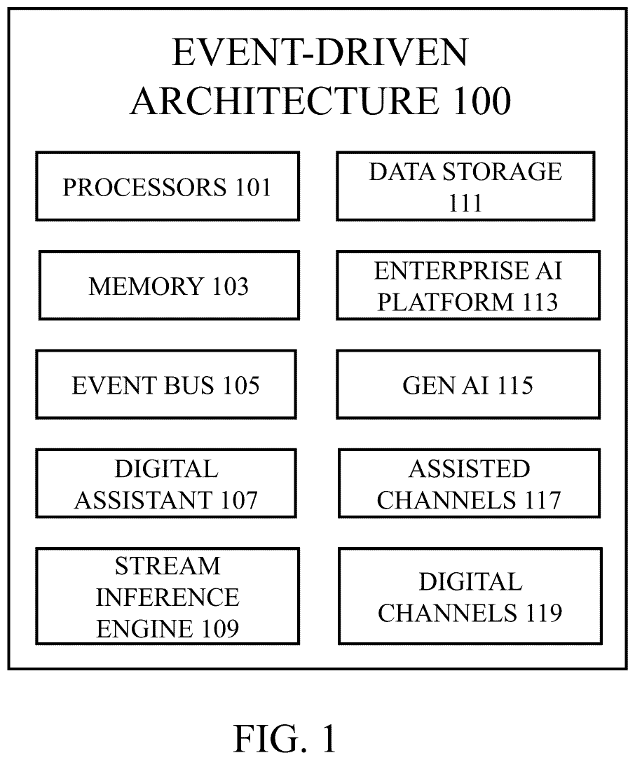

FIG. 1 shows an event-driven architecture 100 that is utilized to carry out the techniques described herein for generating customer servicing models. The event-driven architecture 100 includes one or more processors 101, a memory 103, an event bus 105, a digital assistant 107, a stream inference engine 109, a data storage 111, an enterprise AI platform 113, one or more generative artificial intelligence (AI) models 115, one or more assisted channels 117, and one or more digital channels 119. In some examples, the generative artificial intelligence model(s) 115 include(s) one or more large language models. In other examples, the enterprise AI platform 113 includes the generative AI model(s) 115.

To send proactive communication to customers via SMS, emails, push notifications, and so forth, one or more components of the event-driven architecture 100 contributes to generating a proactive communication. In some examples, the proactive communication is sent to a customer via a communication engine. The communication engine may be implemented by the one or more processors 101. In other examples, the proactive communication is sent by at least one of the stream inference engine 109 and the enterprise AI platform 113. Additional examples include a proactive communication being generated by one or both of the stream inference engine 109 and the enterprise AI platform 113, and then sent to the customer via the communication engine.

The one or more processors 101 include any number of Central Processing Units (CPUs) and Graphical Processing Units (GPUs). Processes of generating customer servicing models may be implemented, executed, or otherwise performed by the one or more processors 101. To train data models used to generate proactive messaging, algorithms described herein utilize the one or more processors 101 to generate and store models in the data storage 111 or in any other accessible location for storing data. One or more databases may also be stored in the data storage 111 and accessed by the data models for training or validation purposes. The data storage 111 may include one or more discrete hardware implementations. In an example, the data storage 111 may include a first memory and a second memory. The first and second memory may be physically located within the same computer system or may be located remotely and are accessible over a network, for example.

The memory 103 includes volatile memory and/or non-volatile memory and stores program instructions executed by the one or more processors 101. The event bus 105 can use in-memory data structures such as queues, stacks, or buffers to temporarily store events in the memory 103.

The digital assistant 107 provides an interface to a customer, for example a chat interface implemented on a website. The digital assistant 107 is configured to receive personalized messages for the customer from the enterprise AI platform 113. The enterprise AI platform 113 may include the generative AI model 115 or have access to the generative AI model 115 stored in a separate location, using the generative AI model 115 to generate the personalized messages. In some examples, the digital assistant 107 provides customer activity context data to the event bus 105 via the one or more digital channels 119.

To train the generative AI model 115 or other neural network-based models as described herein, a supervised learning algorithm may be used to initially train and/or re-train data models. In an example, a multilayer perceptron (MLP) algorithm is used to initially train a large language model and to re-train the large language model with new prompt data to linearly separate features that correspond to different customer patterns.

The stream inference engine 109 processes and analyzes continuous streams of data in real-time to generate insights, make decisions, and trigger actions based on incoming data. A trigger action may include an event sent to the event bus 105 that is received by the enterprise AI platform 113. In an example, the trigger action is the result of a pattern recognition process by which the stream inference engine 109 identified a pattern, trend, or anomaly based on customer input received through the one or more digital channels 119 or the digital assistant 107, for example.

Embodiments described herein anticipate the challenges a customer is facing in real time, before they ask for help, utilizing an enterprise AI solution (e.g., the enterprise AI platform 113) built upon a mix of prompts and continuous learning. By identifying clear patterns in historical and real-time customer data across assets and experiences of a financial service provider and a partner of that provider, and then layering insights with predictive modeling, immediate, contextual, omnichannel communication to proactively service customers across any product may be provided.

A technology framework is described herein that combines Generative AI, machine learning, customer behavior analytics from sentiment analysis, predictive modeling, care agent confidence ratings, targeted marketing, and personalization data. The framework continuously builds and optimizes based on the quality and quantity of data provided to AI models therein, thereby facilitating a rapid response to new input(s) from a customer. For example, the enterprise AI platform 113 is immediately activated upon a customer logging in to a website, and then proactively solves many likely problems that the customer may be facing by using a customer servicing model. The customer servicing model will continuously learn and identify context to, in some examples, prompt the enterprise AI platform 113 to ask the customer relevant questions through the digital assistant 107 even before a customer calls in.

An AI smart assistant (e.g., the digital assistant 107) may be provided with personal historical context from a backend Large Language Model (e.g., the generative AI model 115) and predict how to best assist before being prompted by a customer. Customers can click on the AI assistant to see personalized context for immediate answers. Customers can speak into a mobile app and interact with the AI smart assistant through voice recognition. The technology framework can recognize stress signals in a customer's voice, to then alert customer care that a call may be received and provide appropriate resources. If a customer calls, they will be sent to an agent rated highest in a predicted error resolution category. Agent score cards may be continuously optimized from customer sentiment analysis.

If a financial service provider's services are down, using the technology framework described herein, the provider can still proactively notify all customers or solely the customers predicted to attempt that service on the same day the services are down. Using this technology framework, the provider can proactively communicate, gray out areas on a mobile application or website, and utilize knowledge across systems to generate when the service is estimated or predicted to be repaired. If a customer abandons an action, they will receive personalized, contextual communication across channels addressing their pain point. When applicable, a smart link (e.g., a hyperlink) will be sent to the customer so they may complete their journey from the exact point they previously abandoned.

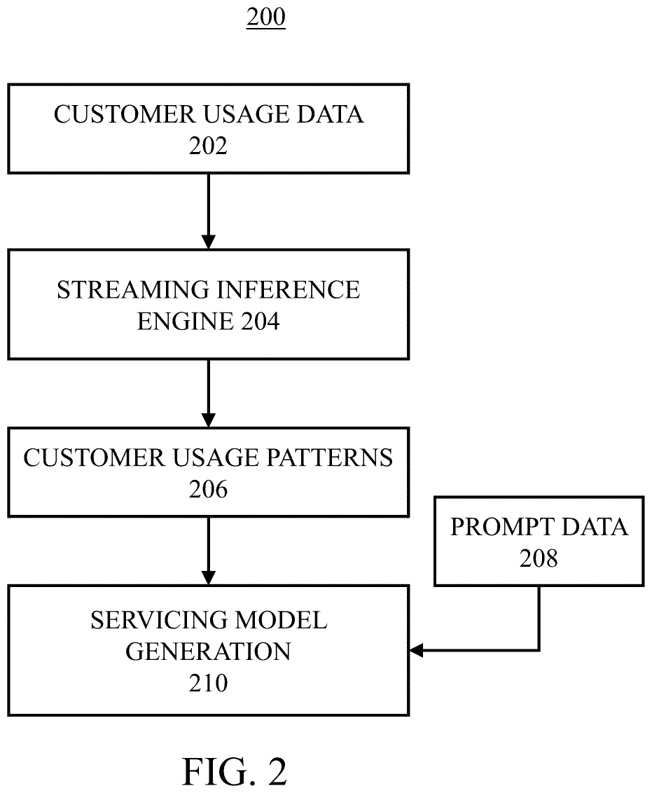

To generate a customer servicing model using the event-driven architecture 100, as an example, a customer servicing model generation process 200 is provided FIG. 2. The generation of a servicing model may begin with a customer usage data process 202 included in the customer servicing model generation process 200. Customer usage data obtained in the customer usage data process 202, in at least certain embodiments, is not limited to one type of data source. For example, a source of the customer usage data may be a website or mobile application of a financial service and the usage may be a credit card payment that is in progress, recently completed, or completed prior to the beginning of the customer servicing model generation process 200. In another example, the customer usage data is click data generated from a customer clicking on various elements of a website. In an event-driven architecture, this click data may be received through a digital channel that provides digital clickstream analytics events to an event bus (e.g., the event bus 105), and then on to an event consumer, such as an enterprise AI platform.

The customer usage data is provided to a streaming inference engine 204 included in the customer servicing model generation process 200. The streaming inference engine 204 applies predictive analytics (i.e., predictive modelling and predictive communication) to the customer usage data to identify and generate data structures of customer usage patterns. The predictive analytics include, but are not limited to, machine learning (ML), predictive analytics, recommendation algorithms, and sentiment analysis.

The output of the predictive analytics is provided to a customer usage patterns process 206 included in the customer servicing model generation process 200. The customer usage patterns 206 process gathers and stores any number of patterns identified by the customer usage patterns process 206. Also included in the customer servicing model generation process 200 is a prompt data process 208. The prompt data process 208 includes generating and storing prompts produced for and/or by a neural network-based model. In certain examples, the neural network-based model is a generative artificial intelligence (AI)-based model. In some examples, the model may be a large language model (LLM).

A prompt may include a customer action or series of actions, such as a mouse click or sequence of mouse clicks on a website or mobile application, and may include alphanumeric textual input actions, such as keyboard strokes or voice-to-text output. In an example, the prompts are provided by a customer and used to train or tune a large language model. In another example, the prompts are generated by a generative AI model (e.g., the generative AI model 115). The prompt data and the customer usage patterns are provided to a servicing model generation process 210.

A large language model, as used in certain embodiments, may be trained and/or re-trained on one or more of natural language text, text derived from speech, click activity on a website or mobile application, a sequence of user actions, and financial data (e.g., prices of items over time, stock price). Large language models may be trained initially using transaction data or they may be pre-built and the fine-tuned or re-trained to leverage a widespread general knowledge as a starting point that is refined for specific tasks (e.g., determining a customer's spending patterns, habits, preferences). Accordingly, in certain examples, a large language model is a neural network-based model that captures prompt data.

The servicing model generation process 210 generates, stores, and/or updates one or more customer servicing models that facilitate proactive engagement with a customer. The models continuously learn based on customer input and are capable of providing the customer with personalized, contextual information for a variety of scenarios. Some scenarios include a customer cannot complete an online payment, a customer abandons an action on a website, and the website goes down. The model, in some examples, is a Transformer-based model. The Transformer-based model may be based on attention mechanisms, positional coding, and an encoder-decoder architecture.

The following is an end-to-end example incorporating the event-driven architecture 100 and the customer servicing model generation process 200. In this example, a customer is on a payment page of a financial service provider. The customer may be interacting with a chatbot (e.g., the digital assistant 107) or may have just logged in to the website. Customer usage data generated by this process (e.g., the customer usage data process 202) is used to proactively identify next steps in real time (e.g., do they want to pay statement in full, or $50?). If they abandon the journey towards completing the payment, a snapshot of the data may be saved (e.g., by the one or more processors 101) and the customer may be offered an option to resume the journey via a smart link provided through a smart assistant communication engine, (e.g., the streaming inference engine 204) based on processing by Generative AI (e.g., processing by the enterprise AI platform 113). If payment functionality at the website is down, the customer can be notified with a personalized message (e.g., “you typically make a payment of $50 on Tuesdays, services are currently down and are estimated to resume at 3 P.M. EST, would you like us to make the $50 payment for you as soon as services resume?”). The customer is provided personalized service to such a granular extent, late payments could be avoided. Models generated in this example (e.g., models generated and updated in the servicing model generation process 210) can solve any functionality or customer journey across consumer and enterprise issues by replicating: what issue is the customer facing, what is the task in hand, what actions will be taken in response, and what the result of it will look like.

Call centers employ many care agents and currently, one solution to pairing an incoming customer call with a care agent is to simply find the next available agent. This approach, despite its simplicity, has many significant drawbacks. For example, being connected to the next available care agent may negatively affect a customer due to the lack of personalization. Predicting that a specific customer is likely to call in provides time to prepare for determining the most suitable care agent. By understanding the context of a customer's inquiry as well as their history of interactions with particular merchants, types of transactions, and so forth, a care agent may be selected that is most likely to be successful and/or efficient at resolving inquires having a similar context.

The following is an example incorporating the event-driven architecture 100 and the customer servicing model generation process 200 to provide better customer service to a customer. In this example, the customer is attempting to complete an action on a website of a financial service provider (e.g., customer usage data process 202). Based on customer analytics from sentiment analysis and predictive modeling (e.g., including the streamlining inference engine 204), a care agent confidence rating may be generated. The care agent confidence rating may be based, for example, on a customer servicing model (e.g., a deep neural network based on a Transformer architecture). Before the customer proceeds to contact a care agent themselves, the customer servicing model may preemptively determine which agent is available (e.g., accessible through the one or more assisted channels 117) and the enterprise AI platform (e.g., the enterprise AI platform 113) may send a personalized message to the customer (e.g., through the digital assistant 107). The personalized message may include a digital link that when selected by the customer, establishes a connection with the care agent.

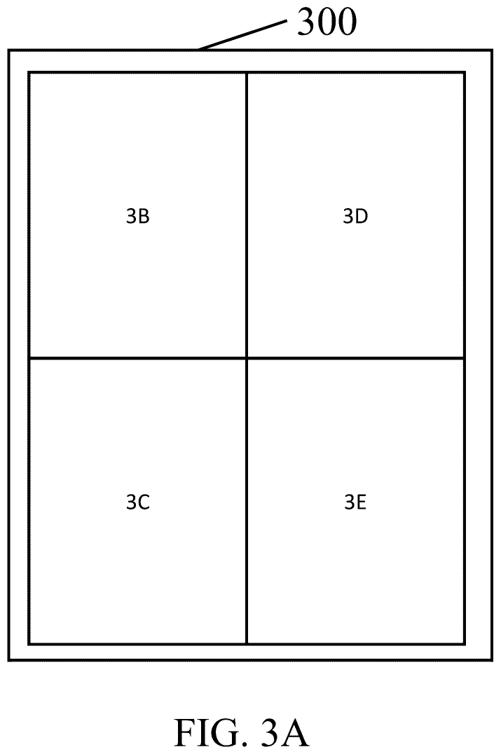

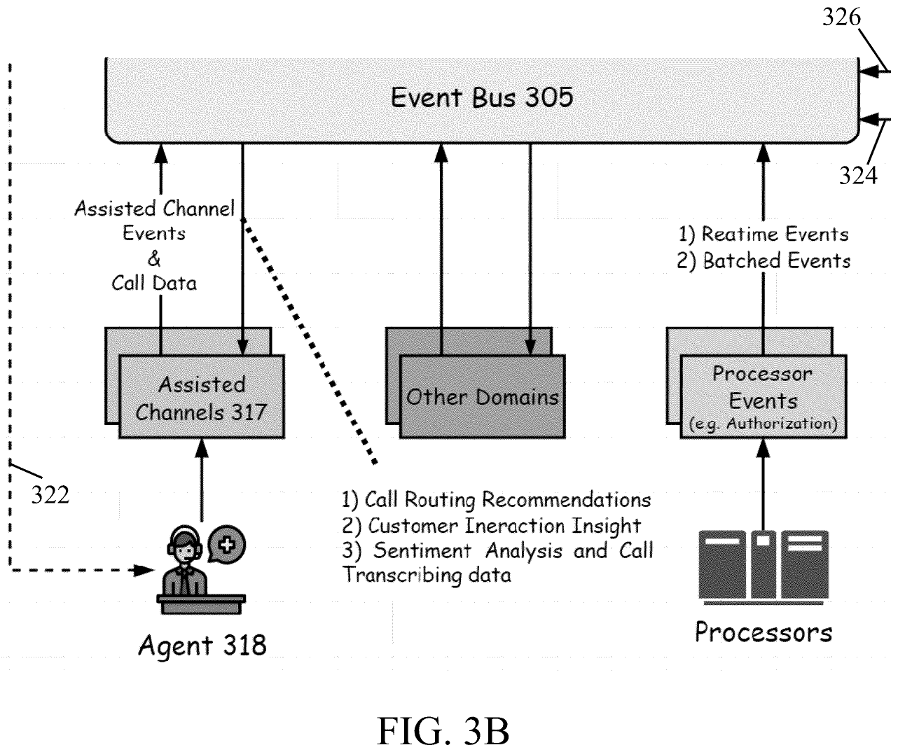

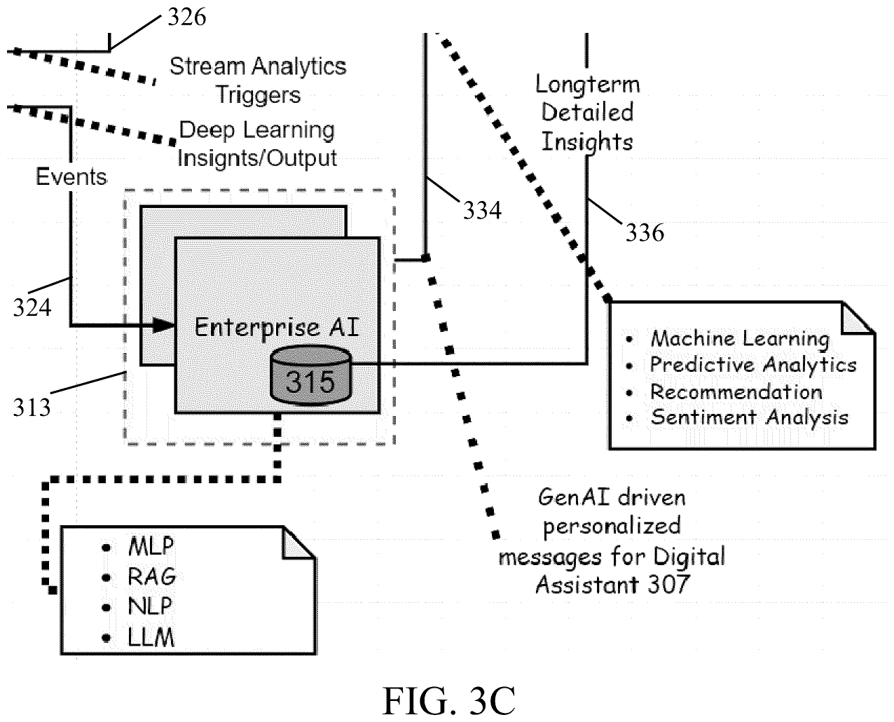

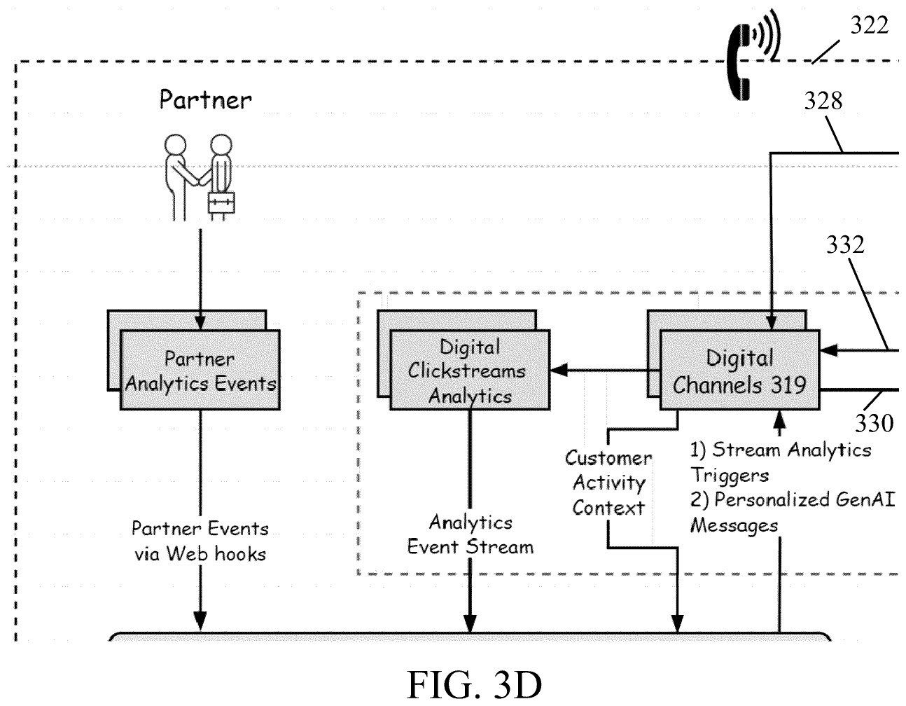

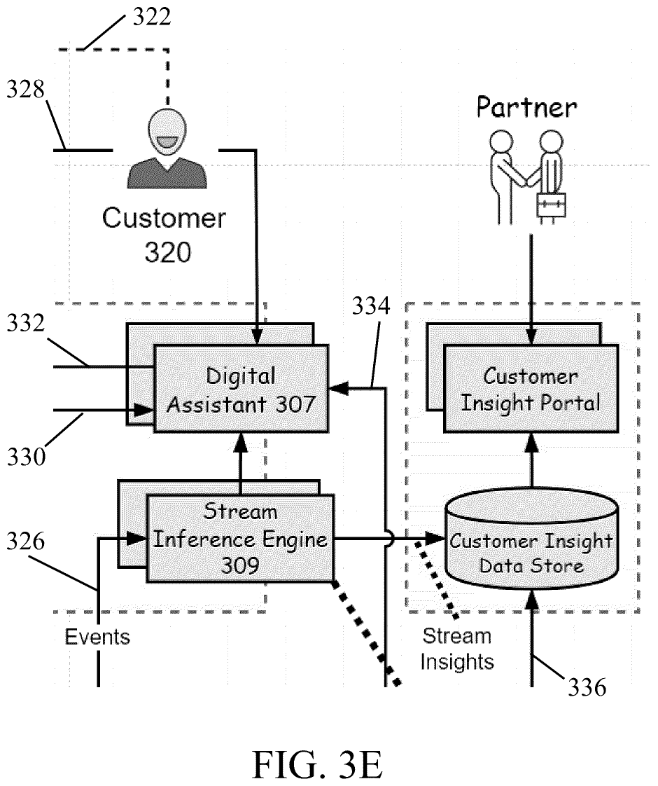

As another example of the techniques and embodiments described herein, an event-driven architecture 300 that includes back-end details and a customer process is shown in FIG. 3A. As shown in FIG. 3A, FIG. 3B abuts FIG. 3D on its right side and abuts FIG. 3C on the lower side of FIG. 3B, FIG. 3C abuts FIG. 3B on the upper side of FIG. 3C and abuts FIG. 3E on the right side of FIG. 3C, FIG. 3E abuts FIG. 3C on the left side of FIG. 3C and abuts FIG. 3D on its upper side, and FIG. 3D abuts FIG. 3B on its left side and abuts FIG. 3E on the lower side of FIG. 3D.

The event-driven architecture 300 includes assisted channels 317 that provide assisted channel events and call data from one or more care agents 318 and one or more digital channels 319 to provide customer activity context to an event bus 305 and receive one or more of stream analytics triggers and personalized messages from the event bus 305. The event bus 305 communicates events to and from a stream inference engine 309 and an enterprise AI platform 313 included in the event-driven architecture 300. A customer 320 interacts with the event-driven architecture through a digital assistant 307 and/or the digital channels 319. In at least one example, some or all of the components and/or processing in the event-driven architecture 300 may be substantially similar or identical to components of the event-driven architecture 100 and/or the customer servicing model generation process 200.

A communication link between the one or more care agents 318 and the customer 320 is provided via a signal 322. Event data is provided between the enterprise AI platform 313 and the event bus 305 via a signal 324 and between the stream inference engine 309 and the event bus 305 via a signal 326. The customer 320 provides data to the digital channels 319 via a signal 328. The digital channels 319 provide data to the digital assistant 307 via a signal 330 and receive data from the digital assistant 307 via a signal 332. The enterprise AI platform 313 provides data (e.g., personalized messages) to the digital assistant 307 via a signal 334 and one or more long term detailed insights to a data store (e.g., data storage 111) via a signal 336.

The following are examples of customer processes including back-end details of the event-driven architecture 300.

The customer 320 logs in to a digital channel of a financial service provider (e.g., mobile app or desktop). The event-driven architecture 300 starts processing data on the backend with the enterprise AI platform 313 and gives the customer 320 an option to go through the digital assistant 307 automatically.

The enterprise AI platform 313 runs algorithms in real time to predict what the customer 320 is looking to do. For example, a machine learning model trained on usage data from the customer 320 (e.g., via the stream inference engine 309), indicates to the enterprise AI platform 313 that the customer 320 always (or frequently) makes payments on a Wednesday and it is a Wednesday. So, the enterprise AI platform 313 provides a personalized message to the customer 320 based on an output from a large language model 315: “Trying to make a payment?” The message may be provided through the digital assistant 307. The customer 320 can confirm by voice command or typing. The customer 320 can say, “yes I am” and the enterprise AI system 313 will automatically make the payment on behalf of the customer 320.

If a service is down, customers who typically utilize the service on a certain day are notified and the area is blacked out on mobile app, producing a message in the digital assistant 307 such as “Payment service is temporarily down and is estimated to be back up and running around 3 PM EST—would you like us to make a payment for you as soon as functionality is fixed?” The customer 320 may provide a response such as “Yes for $50.” The customer 320 is then sent a screen shot of the payment details which go through as soon as the service is back up and running.

The enterprise AI platform 313 has access to real time co-branded partner data and communication. The customer 320, for example, has earned rewards points tied to a co-branded credit card of a financial provider and asks into a mobile application (e.g., via the digital channel 319), “Can I use my rewards on the partner's website?” Pending confirmation by the financial service provider, the rewards may be automatically applied to the customer's account with the partner. In some examples, customer usage data and any other related data is captured and optimized at an account level.

Implementations of the event-driven architecture 300 use voice recognition and notice if the customer 320 is under stress in AI mobile app interaction, for example. This increases a likelihood that the customer 320 will call customer support. Then, when the customer 320 calls, the enterprise AI platform 313 directs the customer 320 to an agent 318 with a highest scorecard in the area that the customer is likely calling about (e.g., payment issues). Based on the answers provided by the agent 318, a model (e.g., generated in the servicing model generation 210) may be maintained by the enterprise AI platform 313 will continuously improve. Additionally, the outcome of the call may be used to update a scorecard for the agent 318. The model captures the entire conversation between agent and customer. In addition, keywords and sentiment may be derived from customer usage data during or before the customer 320 contacts the agent 318, which is fed back into the model to update it.

While the techniques described herein provide AI-enabled responses to customers in real-time, the processes of continuously learning and updating the models may also be performed in the background. As such, customer data for large numbers of customers and care agent data for large numbers of care agents at one or multiple call centers may be continuously or periodically analyzed to learn the patterns and trends that lead to efficient and successful outcomes. In at least some embodiments “continuously updating” includes updating a customer servicing model in real time. In other embodiments, the updating occurs according to a timing schedule such as a periodic schedule (e.g., once per week) or an aperiodic schedule (e.g., whenever customer input is received).

At this point it should be noted that event-driven architectures and customer servicing models generated thereby in accordance with the present disclosure as described above may involve the processing of input data and the generation of output data to some extent. This input data processing and output data generation may be implemented in hardware or software. For example, specific electronic components may be employed in a backend of a computer system using one or more processors or similar or related circuitry for implementing the functions associated with machine learning and training large language models in accordance with the present disclosure as described above. For example, a data center including hundreds or even thousands of rack servers may facilitate operations of event-driven architectures described herein. Alternatively, one or more processors (e.g., the processors 101) executing instructions may implement the functions associated with generating customer servicing models and operating computer systems implementing event-driven architectures in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves. The software may be written in a programming language including one or more of, but not limited to, C, C#, C++, JavaScript, Python, Ruby, R, SQL, PHP and variants thereof. Embodiments described herein are not limited to these languages.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. For example, the techniques described herein span across companies, not just customers and can be used for employee solutioning in their role or solutioning across company-wide intranet areas. Accordingly, the claims set forth below should be construed in view of the full breadth and spirit of the present disclosure as described herein.

1. A system having an event-driven architecture that facilitates proactive engagement with a customer, the system comprising:
a memory storing instructions;
a data storage that stores prompt data of one or more customer actions, wherein the prompt data is created by generating and storing prompts produced for and by a neural network-based model; and
one or more processors that execute the instructions to:
receive customer input data from the customer;
provide the customer input data to a streaming inference engine that identifies one or more customer usage patterns, wherein the streaming inference engine is trained on usage data associated with the customer to generate data structures comprising the one or more customer usage patterns;
generate a customer servicing model based on the one or more customer usage patterns and the prompt data;
store the customer servicing model in the data storage;
provide an output to the customer based on the customer servicing model; and
continuously update the customer servicing model stored in the data storage.

2. The system of claim 1, wherein continuously update the customer servicing model comprises update the customer servicing model according to a timing schedule.

3. The system of claim 1, wherein the customer servicing model is a deep neural network based on a Transformer architecture.

4. The system of claim 1, wherein the customer input data is received through a digital assistant and the one or more processors execute the instructions upon determining the customer logged in to a website that provides the digital assistant.

5. The system of claim 4, wherein the one or more processors execute the instructions to:
identify the one or more customer usage patterns using the streaming inference engine; and
acquire the prompt data from a plurality of customer interactions with the digital assistant.

6. The system of claim 1, wherein the one or more processors further execute the instructions to communicatively couple an event bus to one or more digital channels.

7. The system of claim 6, wherein the one or more processors further execute the instructions to receive the customer input data from the one or more digital channels through the event bus.

8. The system of claim 6, wherein the one or more processors execute the instructions to:
generate, by an Enterprise AI platform, one or more personalized messages based on providing the customer input data to a generative artificial intelligence-based model; and
provide the one or more personalized messages to the customer in the output.

9. The system of claim 1, wherein the one or more processors execute the instructions to communicatively couple an event bus to one or more assisted digital channels.

10. The system of claim 1, wherein the one or more processors execute the instructions to:
determine a type of sentiment by performing a sentiment analysis of the customer input data;
determine a customer care agent score associated with the type of sentiment; and
establish a connection from the customer to the customer care agent through the one or more assisted channels, the connection included in the output.

11. The system of claim 10, wherein the customer input data comprises voice data and the type of sentiment comprises a level of stress.

12. The system of claim 1, wherein the one or more processors execute the instructions to:
determine the customer abandoned an action on a webpage;
save a snapshot of data based on the abandoned action; and
provide a selectable digital link to the customer in real time to resume the action upon selecting the selectable link, the selectable link included in the output.

13. A method of operating a system having an event-driven architecture that facilitates proactive engagement with a customer, the method comprising the steps of:
storing instructions in a memory;
storing prompt data of one or more customer actions in a data storage, wherein the prompt data is created by generating and storing prompts produced for and by a neural network-based model; and
one or more processors executing the instructions to:
receive customer input data from the customer;
provide the customer input data to a streaming inference engine that identifies one or more customer usage patterns, wherein the streaming inference engine is trained on usage data associated with the customer to generate data structures comprising the one or more customer usage patterns;
generate a customer servicing model based on the one or more customer usage patterns and the prompt data;
store the customer servicing model in the data storage;
provide an output to the customer based on the customer servicing model; and
continuously update the customer servicing model stored in the data storage.

14. The method of claim 13, wherein continuously update the customer servicing model comprises update the customer servicing model according to a timing schedule.

15. The method of claim 13, wherein the customer servicing model is a deep neural network based on a Transformer architecture.

16. The method of claim 13, wherein receive the customer input data comprises receive the customer input data through a digital assistant and the one or more processors execute the instructions upon determining the customer logged in to a website that provides the digital assistant.

17. The method of claim 13, wherein the one or more processors execute the instructions to:
determine a type of sentiment by performing a sentiment analysis of the customer input data;
determine a customer care agent score associated with the type of sentiment; and
establish a connection from the customer to the customer care agent through the one or more assisted channels, the connection included in the output.

18. The method of claim 17, wherein the customer input data comprises voice data and the type of sentiment comprises a level of stress.

19. The method of claim 13, wherein the one or more processors execute the instructions to:
determine the customer abandoned an action on a webpage;
save a snapshot of data based on the abandoned action; and
provide a selectable digital link to the customer in real time to resume the action upon selecting the selectable link, the selectable link included in the output.

20. At least one non-transitory processor readable storage medium storing a computer program of instructions configured to be readable by at least one processor for instructing the at least one processor to execute a computer process for performing the method as recited in claim 13.
